(19) United States
(12) Patent Application Publication
(10) Pub. No.: US 2016/0263771 A1
(43) Pub. Date: Sep. 15, 2016

(54) Oil Borne Preservative Removal By Torrefaction

(71) Applicant: Nisus Corporation, Knoxville, TN (US)

(72) Inventors: Jeffrey D. Lloyd, Knoxville, TN (US); Pyoungchung Kim, Knoxville, TN (US); Nicole Labbe, Knoxville, TN (US); Jae Woo Kim, Knoxville, TN (US)

(73) Assignees: Nisus Corporation, Knoxville, TN (US); University of Tennessee Research Foundation, Knoxville, TN (US)

(21) Appl. No.: 15/151,077

(22) Filed: May 10, 2016

Related U.S. Application Data
(63) Continuation-in-part of application No. 15/067,265, filed on Mar. 11, 2016.
(60) Provisional application No. 62/132,698, filed on Mar. 13, 2015.

(51) Int. Cl. B27K 5/00; C10L 5/44; C10L 9/10; C05F 11/00; C10L 3/00; C10L 5/36; C10L 5/10; C09K 17/02; C10L 9/08; C10J 3/72

(52) U.S. Cl. CPC B27K 5/0085; C10L 9/083; C10L 5/442; C10L 9/10; C10J 3/72; C10L 3/00; C10L 5/363; C10L 5/10; C09K 17/02; C05F 11/00; B27K 2240/15; C10L 2290/06; C10L 2290/28; C10L 2200/0469; C10L 2290/02; C10J 2300/0906; C10J 2300/092; C10J 2300/16

(57) ABSTRACT

A method for removing hazardous air pollutants and contaminants from a wood product is disclosed. In a first step, a contaminated wood product is placed in a treatment vessel. This wood product includes an initial amount of an absorbed contaminant, selected from the group consisting of creosote, a mixture of pentachlorophenol and a carrier oil, a mixture of copper naphthenate and a carrier oil, and combinations thereof In a second step, the wood product is heated to a treatment temperature sufficient to evaporate at least a portion of the absorbed contaminant from the wood product but insufficient to pyrolyze the wood product. The wood product is then maintained at the treatment temperature for a period of time sufficient to reduce the absorbed contaminant in the wood product to a final amount which is less than about 20% of the initial amount. Optionally, the desorbed wood may then be treated with a chemical to remove inorganic impurities that are detrimental during thermochemical conversion of biomass. A decontaminated wood product is also disclosed.

### CROSS-REFERENCE TO RELATED APPLICATIONS

This application is a continuation-in-part of application Ser. No. 15/067,265, filed Mar. 11, 2016, the disclosure of which is herein incorporated by reference. This application also claims the benefit of the earlier filing date of provisional patent application, 62/132,698, filed Mar. 13, 2015, the disclosure of which is also herein incorporated by reference.

### FIELD

This invention relates in general to the field of wood preservation. More particularly, this invention relates to a method for separating wood preservative compositions contaminants and hazardous air pollutants from previously treated wood products.

### BACKGROUND

Wooden materials are subject to damage caused by various environmental factors such as weather, heat, and living organisms, such as fungi or bacteria. Water and fungi may penetrate into the wood leading to decay, rot and a decrease in the strength, form and overall structure and quality of the wood. Consequently, wood treatment methods using various chemicals have been used in an effort to prevent or slow the damage caused to wood products by fungi, insects or water.

Examples of common wood treatment chemicals include creosote, pentachlorophenol, and copper naphthenate. While they are effective in preserving and extending the service life of wood materials, the use of such chemicals may at the same time raise health and/or environmental concerns. In particular, when wood products which have been treated with preservatives such as creosote, pentachlorophenol, or copper naphthenate reach the end of their service life, the inclusion of these preservatives in the wood may impose restrictions on the re-use or energy capture of the wood materials as the preservative or carrier oil can constitute an unnatural contaminant that contains hazardous air pollutants. The treated wood materials may have to be wastefully disposed of as waste, typically in costly landfill or by incineration.

It would be desirable therefore to provide the benefits of wood treatment chemicals such as creosote, pentachlorophenol, and copper naphthenate to wood products without having to later dispose of the wood product as a contaminated waste product at the end of its service life. It would also be desirable to reuse or recycle all or portions of the treated wood product at the end of its service life.

### SUMMARY

The above and other needs are met by the present disclosure which, in a first aspect, provides a method for removing contaminants from a wood product. According to one embodiment, the method includes at least the following steps. In a first step, a contaminated wood product is placed in a treatment vessel. This wood product includes an initial amount of an absorbed contaminant selected from the group consisting of creosote, a mixture of pentachlorophenol and a carrier oil, a mixture of copper naphthenate and a carrier oil, and combinations thereof. In a second step, the wood product is heated to a treatment temperature sufficient to evaporate at least a portion of the absorbed contaminant from the wood product but insufficient to pyrolyze the wood product. The wood product is then maintained at the treatment temperature for a period of time sufficient to reduce the absorbed contaminant in the wood product to a final amount which is less than about 20% of the initial amount.

Optionally, after the heating and maintaining steps, the wood product may be further treated with a chelating agent in order to remove removing inorganic impurities present in the wood product.

According to certain embodiments of the method, the final amount of absorbed contaminant in the wood product is preferably less than about 10% of the initial amount of absorbed contaminant in the wood product.

According to certain embodiments of the method, the treatment temperature is preferably from about 200° C. to about 350° C. More preferably, the treatment temperature is from about 240° C. to about 280° C.

According to one embodiment of the method, the absorbed contaminant preferably includes creosote in an initial amount of from about 1 to about 10 pounds of creosote per cubic foot of wood product.

According to a second preferred embodiment of the method, the absorbed contaminant preferably includes a mixture of pentachlorophenol and a carrier oil in an initial amount of from about 0.1 to about 1.2 pounds of pentachlorophenol and about 1 to about 6 pound of carrier oil per cubic foot of wood product.

According to third preferred embodiment of the method, the absorbed contaminant preferably includes mixture of copper naphthenate and a carrier oil in an initial amount of from about 0.1 to about 1.2 pounds of copper naphthenate and about 1 to about 6 pound of carrier oil per cubic foot of wood product.

According to one preferred embodiment of the method, the absorbed contaminant preferably includes creosote in a final amount of from about 0 to about 1.0 pounds of creosote per cubic foot of wood product.

According to a second preferred embodiment of the method, the absorbed contaminant preferably includes a mixture of pentachlorophenol and a carrier oil in an final amount of from about 0 to about 0.1 pounds of pentachlorophenol and about 0 to about 1 pound of carrier oil per cubic foot of wood product.

According to third preferred embodiment of the method, the absorbed contaminant preferably includes a mixture of copper naphthenate and a carrier oil in an final amount of from about 0 to about 0.1 pounds of copper naphthenate and about 0 to about 1 pound of carrier oil per cubic foot of wood product.

According to certain embodiments of the method, the treatment vessel includes a vapor phase inside the treatment vessel and this vapor phase includes less than about 5 percent oxygen during the heating and maintaining steps.

According to certain embodiments of the method, the treatment vessel includes a vapor phase inside the treatment vessel and this vapor phase is held at a sub-atmospheric pressure during the heating and maintaining steps.

According to certain embodiments, the method also includes a further step of collecting and condensing at least a portion of the evaporated contaminant.

According to certain embodiments, the method also includes a further step of comminuting the contaminated wood product into particles having an average weight of less than about 100 grams, and more preferably less than 1 gram, prior to the heating and maintaining steps.

According to certain embodiments, the method also includes a further step of preheating the wood product to a temperature from about 60° C. to about 120° C. for a time sufficient to reduce the moisture level in the wood product below about 10 percent.

According to certain embodiments, the method also includes a further step of pyrolyzing or gasifying the decontaminated wood product at a temperature from about 350° C. to about 500° C.

In a second aspect, the present disclosure provides a decontaminated wood product. According to one embodiment, the decontaminated wood product is prepared by a method which includes at least the following steps. In a first step, a contaminated wood product is placed in a treatment vessel. This wood product includes an initial amount of an absorbed contaminant selected from the group consisting of creosote, a mixture of pentachlorophenol and an carrier oil, a mixture of copper naphthenate and a carrier oil, and combinations thereof. In a second step, the wood product is heated to a treatment temperature sufficient to evaporate at least a portion of the absorbed contaminant from the wood product but insufficient to pyrolyze the wood product. The wood product is then maintained at the treatment temperature for a period of time sufficient to reduce the absorbed contaminant in the wood product to a final amount which is less than about 20% of the initial amount, and thereby provide a decontaminated wood product.

According to certain embodiments of the decontaminated wood product, the mass of the decontaminated wood product on a dry basis is preferably at least 90 percent of the mass of the contaminated wood product on a dry basis.

In a further aspect of the disclosure, numerous articles may be prepared from the decontaminated wood product. According to one embodiment, a composite wood product may be formed which includes at least the decontaminated product and an adhesive. In another embodiment, a soil amendment product may be formed which includes the decontaminated product and at least additional soil additive. In still another embodiment, the fuel product may be formed which is made from decontaminated wood product, wherein the decontaminated wood product is formed into pellets. This fuel product may also further include a binding agent or additional organic material. In yet another embodiment, a gaseous fuel product may be prepared by gasification of the decontaminated wood product.

In still another aspect, the present disclosure provides a method for recycling wood preservatives. According to one embodiment, the method includes at least the following steps. In a first step, a contaminated wood product is placed in a treatment vessel. This wood product includes an initial amount of an absorbed contaminant selected from the group consisting of creosote, a mixture of pentachlorophenol and a carrier oil, a mixture of copper naphthenate and a carrier oil, and combinations thereof In a second step, the wood product is heated to a treatment temperature sufficient to evaporate at least a portion of the absorbed contaminant from the wood product but insufficient to pyrolyze the wood product. The wood product is then maintained at the treatment temperature for a period of time sufficient to reduce the absorbed contaminant in the wood product to a final amount which is less than about 20% of the initial amount. At least a portion of the evaporated preservative is recovered. In a subsequent step, a second wood product is treated by applying a composition to the second wood product which includes at least a portion of this recovered preservative. In a preferred embodiment, the second wood product may be either a new wooden railroad tie or a new wooden telephone pole.

In still another aspect, the present disclosure provides a method for removing contaminants and other materials from a wood product. According to one embodiment, the method includes at least the following steps. In a first step, a contaminated wood product provided. This wood product includes an initial amount of an absorbed contaminant selected from the group consisting of creosote, a mixture of pentachlorophenol and a carrier oil, a mixture of copper naphthenate and a carrier oil, and combinations thereof. In a second step, the wood product is heated to a temperature from 60° C. to about 120° C. for a period of time sufficient to reduce the amount of moisture in the wood product to less than about 10%. Then, in a third step, the wood product is heated to a temperature from 240° C. to about 280° C. for a period of time sufficient to thermally de-sorb the absorbed contaminant in the wood product to a final amount which is less than about 20% of the initial amount. Then, in a fourth step, cellulosic by-products are recovered from the wood product by heating the wood product to a temperature from about 280° C. to about 365° C. for a period of time sufficient to reduce the cellulosic by-products in the wood product by at least 50%. Then, in a fifth step, phenolic derivatives are recovered from the wood product by heating the wood product to a temperature from about 365° C. to about 450° C. for a period of time sufficient to reduce the phenolic derivatives in the wood product by at least 50%. Advantageously, according to this method, a variety of useful by-products may each by separately recovered from the wood.

### DETAILED DESCRIPTION

The aforementioned and other needs are met by a method for removing contaminants from a wood product. According to one embodiment, the method includes at least the following steps. In a first step, a contaminated wood product is placed in a treatment vessel. This wood product includes an initial amount of an absorbed contaminant selected from the group consisting of creosote, a mixture of pentachlorophenol and a carrier oil, a mixture of copper naphthenate and a carrier oil, and combinations thereof. In a second step, the wood product is heated to a treatment temperature sufficient to evaporate at least a portion of the absorbed contaminant from the wood product but insufficient to pyrolyze the wood product. The wood product is then maintained at the treatment temperature for a period of time sufficient to reduce the absorbed contaminant in the wood product to a final amount which is less than about 20% of the initial amount.

The treatment method of the present disclosure may be used for decontamination of various wood products which are at or near the end of their service life and into which some form of undesired contaminant has been absorbed. Used wood products which may be treated according to the method include, for instance, railroad ties, bridge ties, utility poles and other wood products intended for outdoor use. These wood products have typically been previously treated with a preservative such as creosote, a mixture of pentachlorophenol and a carrier oil, a mixture of copper naphthenate and a carrier oil, a combination of such preservatives. More generally, the treatment method can also be used to extract oil borne preservatives and or contaminants from any other oil borne or carried preservative system, and from wood treated with such preservatives that has been mixed together, such as poles treated with pentachlorophenol and railroad ties treated with creosote.

Such treatments beneficially preserve the wood product during its useful life and allow the use of wood in place of other materials, such are concrete or steel, whose use would have a greater impact on the environment.

Once the wood product reaches the end of this useful life, however, such preservatives then become a detriment and may be considered an undesired absorbed contaminant. So long as this absorbed contaminant is present, the wood product in some instances may be considered a restricted waste. As such, re-use of the wood in the fabrication of other products is prevented, as well as energy recapture of the wood as a fuel source such as boiler fuel. Instead, the wood product must be disposed of which is wasteful, restricted and expensive.

The present disclosure, however, provides a method by which the absorbed contaminants may be substantially removed from the wood product, leaving a decontaminated product which may be used for energy capture, thereby replacing the use of fossil fuels as an energy source. Alternatively, the decontaminated wood product may be reused by being incorporated into a new, second product. And in both instances, the recovered preservative itself may be further used, either by reuse as a preservative or by use as a fuel product.

The initial amount of contaminant absorbed into the wood product may vary depending on the type of preservative originally used to treat the wood product. For wood products originally treated with a creosote preservative, the initial amount of absorbed creosote contaminant in the wood product is typically from about 1 to about 10 pounds of creosote per cubic foot of wood product (pcf). For wood products originally treated with a pentachlorophenol preservative, the initial amount of absorbed pentachlorophenol contaminant in the wood product is typically from about 0.1 to about 1.2 pounds of pentachlorophenol and about 1 to about 6 pound of carrier oil per cubic foot of wood product. For wood products originally treated with a copper naphthenate preservative, the initial amount of absorbed copper naphthenate contaminant in the wood product is typically from about 0.1 to about 1.2 pounds of copper naphthenate and about 1 to about 6 pound of carrier oil per cubic foot of wood product.

According to the method, the contaminated wood product is placed in a treatment vessel, which may be a metal tank or other suitable structure for holding the contaminated wood product during the decontamination treatment. The treatment vessel is typically constructed from metal, such as stainless steel, or from another material which is capable of withstanding the operating temperatures associated with the decontamination process.

In some embodiments, the treatment vessel may be open topped or otherwise vented to ambient, atmospheric pressure. In other instances, however, the treatment vessel may be a pressure vessel which is capable of being sealed substantially airtight, so that the vapor phase conditions within the treatment vessel may be better controlled. For example, in some embodiments a sub-atmospheric pressure may be established in the treatment vessel. In other embodiments of the method, oxygen may be removed from the treatment vessel and/or the treatment vessel may be blanketed with an inert gas.

The present decontamination method may be carried out on either a batch basis (in which the wood remains substantially stationary or is mixed within a treatment vessel during the decontamination) or on a continuous or semi-continuous basis (in which the wood travels through the treatment vessel during the decontamination).

It should also be noted that in some embodiments of the present disclosure, the size of the contaminated wood products may be reduced or comminuted in order to increase the exposed surface area of the wood products and facilitate the decontamination treatment. This may be carried out by grinding, chopping, milling, or otherwise reducing the average size and weight of the contaminated wood products. This size reduction step may be carried out prior to placing the contaminated wood product in the treatment vessel, or alternatively may be carried out within the treatment vessel. In some instances, it may be preferred to reduce the contaminated wood product into particles having an average weight of less than about 100 grams, and more preferably less than 1 gram, prior to the heating and maintaining steps.

Optionally, it may also be desirable to preheat the contaminated wood product at a relatively low temperature in order to reduce the moisture level in the wood product prior to the main heating step. For instance, the wood product may be preheated to a temperature from about 60° C. to about 120° C. The contaminated wood product will typically have an initial moisture content from about 10 to about 50 percent, and the preheating step is carried out for a period of time sufficient to reduce this moisture level in the wood product below about 10 weight percent. Alternatively, the wood product may be air dried by being stored in a covered or arid climate for a period of time sufficient to achieve the desired moisture level in the wood product.

The contaminated wood product is then heated in the treatment vessel to a temperature which is sufficient to evaporate, or thermally de-sorb, at least a portion of the absorbed contaminant from the wood product but insufficient to pyrolyze the wood product. The wood product is maintained at this treatment temperature for a period of time sufficient to reduce the absorbed contaminant in the wood product to a desired final amount, typically less than about 20% of the initial amount.

Heating to the treatment vessel by any suitable means such as by using external electric heating, using steam or oil heated jacketing, by direct firing, or by direct steam injection into the wood material within the treatment vessel.

In general, the treatment temperature is preferably from about 200° C. to about 350° C. More preferably, the treatment temperature is from about 240° C. to about 280° C. The wood is held at this treatment temperature for a period of time sufficient to reduce the absorbed contaminant in the wood product to a final amount which is less than about 20% of the initial amount. In some instances, this may be from about 5 to about 10 minutes.

Treatment of the wood product at these temperatures may be considered to be a torrefaction process, or a thermal desorption process, as distinguished from a pyrolysis process. During pyrolysis, a high degree of thermal degradation occurs to the structure of wood as compounds within the structure of the wood decompose and release water and volatile organic compounds, with much of the remaining wood solids being carbonized or converted to a charcoal-like material sometimes called biochar. Thus, pyrolysis may be considered as an incomplete form of combustion, and typically occurs at higher temperature from about 350 to about 500° C. At the higher end of this temperature range, the pyrolysis process is often called gasification and leaves less carbonized material.

In contrast, the wood torrefaction or de-sorption carried out according to the present disclosure occurs at lower temperatures and does not lead to significant degradation of the wood and does not contaminate the recovered preservative with wood degradation materials. The amount of wood degradation may be assessed by comparing the mass of the wood product, on a dry basis (i.e., excluding the mass of any water or absorbed contaminants), before and after the heating and maintaining steps. Preferably according to the present disclosure, the mass of the final decontaminated wood product on a dry basis is preferably at least 90 percent of the mass of the contaminated wood product on a dry basis.

It is also to be noted that if desired, the vapor phase in the treatment vessel may be held at a subatmospheric pressure during the heating and maintaining (i.e. torrefaction) steps, in order to induce more effective evaporation of the contaminants.

Also, if desired, oxygen may be removed from the treatment vessel and/or the treatment vessel may be blanketed with an inert gas. In some instances, the amount of oxygen in the treatment vessel vapor phase may be reduced to less than about 5 percent oxygen during the heating and maintaining steps.

Upon completion of the heating and maintaining steps, the contaminants in the wood are substantially desorbed, so that the final amount of absorbed contaminant in the wood product is typically less than about 20% of the initial amount of absorbed contaminant in the wood product. In some instances, the final amount of absorbed contaminant in the wood product is less than about 10% of the initial amount of absorbed contaminant in the wood product.

Thus, for instance, if initially contaminated with creosote, the final amount of creosote in the wood product following decontamination is preferably from about 0 to about 1.0 pounds of creosote per cubic foot of wood product.

If initially contaminated with a mixture of pentachlorophenol and a carrier oil, the final amount of pentachlorophenol in the wood product following decontamination is preferably from about 0 to about 0.1 pounds of pentachlorophenol per cubic foot of wood product. The final amount of carrier oil is preferably from about 0 to about 1 pound of carrier oil per cubic foot of wood product.

If initially contaminated with a mixture of copper naphthenate and a carrier oil, the final amount of copper naphthenate in the wood product following decontamination is preferably from about 0 to about 0.1 pounds of copper naphthenate per cubic foot of wood product. The final amount of carrier oil is preferably from about 0 to about 1 pound of carrier oil per cubic foot of wood product.

In addition, the wood product may optionally be subjected to an additional treatment step to reduce the level of inorganic contaminants in the wood. The inorganics may include alkali and/or alkaline earth metals such as potassium, calcium, and magnesium which may be present in elevated amounts in the wood products, as well as nonmetals such as sulfur, phosphorous, and silicon. In this treatment step, the wood product is preferably treated with a chelating agent in order to extract the inorganic contaminants from the wood product. The chelating agent is preferably ethylenediaminetetraacetic acid (EDTA), but other chelating agents may also be employed including acids such as citric acid, acetic acid, and sulfuric acid. This chelating step preferably removes at least 505 of the inorganic impurities in the wood product.

In various embodiments of the present disclosure, the chelating or extracting process may be carried out either before or after the thermal desorption, but is it believed that this treatment is more preferably carried out after the thermal desorption.

Once separated from the wood product by evaporation, the contaminants are preferably recovered. For instance, vapor phase including the contaminants may be collected and cooled in a condenser so that the evaporated contaminants may be recovered in a liquid form. If desired, the recovered contaminants may then be disposed of separately from the now decontaminated wood product.

In a particularly preferred embodiment of the invention, however, the recovered contaminants may be recycled and reused as a preservative for a new wood product. The recovered contaminants may be incorporated into a preservative composition—typically with fresh preservative and/or a solvent—and then applied to a second wood product. For instance, the recovered contaminants maybe advantageously applied to new railroad ties or to new telephone poles.

In some instances, it may be preferred to further process the creosote, or other recovered contaminants, prior to reuse as a preservative for a new wood product. For instance, some amount of water will typically be included with the recovered creosote or other contaminants. At least a portion of this water is preferably separated from the creosote to improve the purity of the creosote. For instance, the water may be separated from the creosote by thermal evaporation or by an oil—water separation process. Moreover, in some instances, it be preferred to add petroleum and/or coal derived products to the recovered creosote prior to reuse, in order to modify the physical properties of the recovered creosote, such as viscosity or density.

As noted above, the decontaminated wood product provided according to the present disclosure typically includes a final amount of absorbed contaminant which is typically less than about 20% of the initial amount of absorbed contaminant in the wood product. More preferably, the final amount of absorbed contaminant is less than about 10% of the initial amount of absorbed contaminant in the wood product. Because of this removal of most of the contaminants from the wood, the decontaminated wood product may be re-used in the fabrication of other products. Alternatively, the decontaminated wood product may be used for energy recapture as a fuel source.

If desired, the decontaminated wood product may be recycled and incorporated into one or more new products. As noted above, the mass of the decontaminated wood product on a dry basis is preferably at least 90 percent of the original wood mass of the contaminated wood product on a dry basis, indicating that relatively little degradation has occurred to the wood structure of the decontaminated wood product. Thus, the decontaminated wood product is suitable for reuse in a variety of further end products.

For instance, according to one embodiment of the present disclosure, a composite wood product may be formed which includes at least the decontaminated wood product and an adhesive. In another embodiment, a soil amendment product may be formed which includes the decontaminated product and at least additional soil additive. In still another embodiment, the fuel product may be formed which is made from decontaminated wood product, wherein the decontaminated wood product is formed into pellets. This fuel product may also further include a binding agent or other organic materials.

The fuel may also be used for complete pyrolysis for the production of other useful materials or for gasification where the resultant gas is burned for energy directly or stored for later use. The gas produced may be wood gas, or if appropriate catalysts are used in the gasification step, a hydrogen-enriched gas.

The gas may for example be used for heating or used to power a generator to make electricity. When the decontaminated wood product is used in this manner, the initial steps of removing the contaminants, as well as moisture, according to the present method significantly improve the value and efficiency of the wood product for use in pyrolysis, gasification or as a solid fuel.

In a particularly preferred embodiment, the wood may be treated in a multi-step process, wherein each stage is progressively hotter than the previous stage. For instance, the wood may initially be heated to a temperature from about 60° C. to about 120° C. in order to remove moisture from the wood. The wood may then be heated to a temperature from about 240° C. to about 280° C. in order to remove contaminants such as creosote from the wood. The wood may then be further heated to a temperature from about 280° C. to about 365° C. in order to remove cellulosic by-products such as sugar acids from the wood. Finally, the wood may be heated to a temperature from about 365° C. to about 450° C. in order to remove phenolic derivatives from the wood. Thus, in this manner, a variety of useful by-products may each by separately recovered from the wood.

### EXAMPLE

In the following Example, used creosote-treated railroad tie (red oak, Quercus rubra) was tested using analytical pyrolysis-gas chromatography/mass spectrometry (Py-GC/MS). The tie was ground into less than 0.425 mm particle sizes with a knife mill before testing. According to the testing procedure, the used creosote-treated tie material was initially heated to a first temperature of either 200° C., 250° C., or 300° C. and held at this temperature for a period of 5 minutes in order to simulate a thermal desorption process.

Vapors released from the railroad tie material during this time were captured and analyzed using GC/MS. Thereafter, the railroad time material was further heated to a temperature of about 450° C. and held at this temperature for a period of about 12 second in order to simulate a fast pyrolysis of the material. Here again, vapors released from the railroad tie material during this time were captured and analyzed using GC/MS. As a control, a sample of creosote—treated railroad tie was also heated directly to 450° C. and subjected to fast pyrolysis, without an initial thermal desorption treatment.

Looking first at the comparative results from the carrying out the thermal desorption at 200° C., 250° C., and 300° C., relatively small GC/MS peaks for poly-aromatic creosote components (such as naphthalene, acenaphthene, fluorene, phenanthrene, anthracene, fluoranthene, and pyrene) were observed at 200° C., indicating that only a small amount of these components were being desorbed from the wood at 200° C. At 250° C., larger amount of poly-aromatic creosote components were detected by GC/MS, along with only small amount of wood-derived decomposition products such as sucrose and levoglucosan. At 300° C., significant amount of poly-aromatic creosote components were again detected, but at this temperature significant amount of cellulosic decomposition products were also detected by GC/MS, such as sucrose, levoglucosan, furfural, ioseugenol, and various cinnamaldehyde derivatives. These results indicate that a preferred temperature range for recovery of creosote components by thermal desorption—without the inclusion of significant amount of wood-derived components may lie between 250° C. and 300° C.

For the second stage fast pyrolysis at 450° C., the GC/MS analysis indicated good recovery of wood-derived components such as levoglucosan, furfural, ioseugenol, and syringol at this temperature. However, significant amounts of creosote components such as phenanthrene, fluoranthene, and pyrene were also observed in the pyrolysis of in the control wood sample (not subjected to thermal desorption first) and in the sample thermally desorbed at 200° C. Thus, these results indicate that the recovery of wood (cellulosic and lignin)-derived components from the fast pyrolysis is much more selective when the creosote-treated wood material is initially thermally desorbed at a temperature between 250° C. and 300° C.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for removing contaminants from a wood product, comprising the steps of:
placing a contaminated wood product in a treatment vessel, the wood product including an initial amount of an absorbed contaminant selected from the group consisting of creosote, a mixture of pentachlorophenol and a carrier oil, a mixture of copper naphthenate and a carrier oil, and combinations thereof;
heating the wood product to a treatment temperature sufficient to evaporate at least a portion of the absorbed contaminant from the wood product but insufficient to pyrolyze the wood product; and
maintaining the wood product at the treatment temperature for a period of time sufficient to reduce the absorbed contaminant in the wood product to a final amount which is less than about 20% of the initial amount.

2. The method of claim 1, wherein the final amount of absorbed contaminant in the wood product is less than about 10% of the initial amount of absorbed contaminant in the wood product.

3. The method of claim 1, wherein the treatment temperature is from about 200° C. to about 350° C.

4. The method of claim 1, wherein the treatment temperature is from about 240° C. to about 280° C.

5. The method of claim 1, wherein the absorbed contaminant comprises creosote in an initial amount of from about 1 to about 10 pounds of creosote per cubic foot of wood product.

6. The method of claim 1, wherein the absorbed contaminant comprises a mixture of pentachlorophenol and a carrier oil in an initial amount of from about 0.1 to about 1.2 pounds of pentachlorophenol and about 1 to about 6 pound of carrier oil per cubic foot of wood product.

7. The method of claim 1, wherein the absorbed contaminant comprises a mixture of copper naphthenate and a carrier oil in an initial amount of from about 0.1 to about 1.2 pounds of copper naphthenate and about 1 to about 6 pound of carrier oil per cubic foot of wood product.

8. The method of claim 1, wherein the absorbed contaminant comprises creosote in an final amount of from about 0 to about 1.0 pounds of creosote per cubic foot of wood product.

9. The method of claim 1, wherein the absorbed contaminant comprises a mixture of pentachlorophenol and a carrier oil in an final amount of from about 0 to about 0.1 pounds of pentachlorophenol and about 0 to about 1 pound of carrier oil per cubic foot of wood product.

10. The method of claim 1, wherein the absorbed contaminant comprises a mixture of copper naphthenate and a carrier oil in an final amount of from about 0 to about 0.1 pounds of copper naphthenate and about 0 to about 1 pound of carrier oil per cubic foot of wood product.

11. The method of claim 1, wherein the treatment vessel includes a vapor phase inside the treatment vessel and the vapor phase comprises less than about 5 percent oxygen during the heating and maintaining steps.

12. The method of claim 1, wherein the treatment vessel includes a vapor phase inside the treatment vessel and the vapor phase is held at a sub-atmospheric pressure during the heating and maintaining steps.

13. The method of claim 1, further comprising a step of collecting and condensing at least a portion of the evaporated contaminant.

14. The method of claim 1, further comprising a step of comminuting the contaminated wood product into particles having an average weight of less than about 100 grams prior to the heating and maintaining steps.

15. The method of claim 1, further comprising a step of comminuting the contaminated wood product into particles having an average weight of less than about 1 gram prior to the heating and maintaining steps.

16. The method of claim 1, further comprising a step of removing inorganic impurities present in the wood product by treating the wood product with a chelating agent after the heating and maintaining steps.

17. The method of claim 1, further comprising a step of pyrolyzing or gasifying the decontaminated wood product at a temperature from about 350° C. to about 500° C.

18. The method of claim 1, further comprising a step of preheating the wood product to a temperature from about 60° C. to about 120° C. for a time sufficient to reduce the moisture level in the wood product below about 10 percent.

19. A decontaminated wood product, prepared by a process comprising the steps of:
placing a contaminated wood product in a treatment vessel, the wood product including an initial amount of an absorbed contaminant selected from the group consisting of creosote, a mixture of pentachlorophenol and an carrier oil, a mixture of copper naphthenate and a carrier oil, and combinations thereof;
heating the wood product to a treatment temperature sufficient to evaporate at least a portion of the absorbed contaminant from the wood product but insufficient to pyrolyze the wood product; and
maintaining the wood product at the treatment temperature for a period of time sufficient to reduce the absorbed contaminant in the wood product to a final amount which is less than about 20% of the initial amount, and thereby provide a decontaminated wood product.

20. The decontaminated wood product of claim 19, wherein the mass of the decontaminated wood product on a dry basis is at least 90 percent of the mass of the contaminated wood product on a dry basis.

21. A composite wood product, comprising the decontaminated wood product of claim 19 and an adhesive.

22. A soil amendment product, comprising the decontaminated wood product of claim 19 and at least additional soil additive.

23. A fuel product, comprising the decontaminated wood product of claim 19, wherein the decontaminated wood product is formed into pellets.

24. The fuel product of claim 23, further comprising a binding agent or other organic material.

25. A fuel product, comprising gas prepared by gasification of the decontaminated wood product of claim 19.

26. A method for recycling wood preservatives, comprising the steps of:
placing a contaminated wood product in a treatment vessel, the wood product including an initial amount of an absorbed contaminant selected from the group consisting of creosote, a mixture of pentachlorophenol and an carrier oil, a mixture of copper naphthenate and a carrier oil, and combinations thereof;
heating the wood product to a treatment temperature sufficient to evaporate at least a portion of the absorbed contaminant from the wood product but insufficient to pyrolyze the wood product;
maintaining the wood product at the treatment temperature for a period of time sufficient to reduce the absorbed contaminant in the wood product to a final amount which is less than about 20% of the initial amount;
recovering at least a portion of the evaporated preservative; and
treating a second wood product by applying a composition to the second wood product which comprises at least a portion of the recovered preservative.

27. The method of claim 26, wherein the second wood product is a wooden railroad tie or a wooden telephone pole.

28. A method for removing contaminants and other materials from a wood product, comprising the steps of:
providing a contaminated wood product, the wood product including an initial amount of an absorbed contaminant selected from the group consisting of creosote, a mixture of pentachlorophenol and a carrier oil, a mixture of copper naphthenate and a carrier oil, and combinations thereof;
heating the wood product to a temperature from 60° C. to about 120° C. for a period of time sufficient to reduce the amount of moisture in the wood product to less than about 10%,
heating the wood product to a temperature from 240° C. to about 280° C. for a period of time sufficient to thermally de-sorb the absorbed contaminant in the wood product to a final amount which is less than about 20% of the initial amount;
recovering cellulosic by-products from the wood product by heating the wood product to a temperature from about 280° C. to about 365° C. for a period of time sufficient to reduce the cellulosic by-products in the wood product by at least 50%;
recovering phenolic derivatives from the wood product by heating the wood product to a temperature from about 365° C. to about 450° C. for a period of time sufficient to reduce the phenolic derivatives in the wood product by at least 50%.
